(19) United States
(12) Patent Application Publication
(10) Pub. No.: US 2009/0289401 A1
(43) Pub. Date: Nov. 26, 2009

(54) Work Positioning Device

(75) Inventor: Teruaki Nagato, Tokyo (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 12/226,138

(22) PCT Filed: Mar. 12, 2007
(86) PCT No.: PCT/JP2007/054777

§ 371 Date: Nov. 3, 2008

(30) Foreign Application Priority Data
Apr. 12, 2006 (JP) 2006-109292

(51) Int. Cl. B23Q 3/15; B23Q 3/06; B25B 11/00

(52) U.S. Cl. 269/8; 269/47

(57) ABSTRACT

Provided is a workpiece positioning device that facilitates the replacement work of a positioning pin and does not require a mechanical mechanism for clamping a workpiece. This is a workpiece positioning device that positions a workpiece (W) by inserting a positioning pin (6) into a positioning hole (Wa) of the workpiece (W), wherein the workpiece positioning device comprises three locking members (5) that grip the positioning pin (6) in a protruding condition, and exert a magnetic attractive force, and three sliding members (3) that move each of the three locking members (5) forward and backward radially with respect to the positioning pin (6). The locking member (5) is formed in the shape of a cylindrical column, and grips the positioning pin (6) with an outer circumferential surface (5a) thereof and magnetically attracts the workpiece (W) with a top surface (5a) thereof. The magnetic attractive force of the locking member (5) is adjusted by excitation means.

### TECHNICAL FIELD

The present invention relates to a workpiece positioning device that is used to position a plate-like workpiece in a jig.

### BACKGROUND ART

As a device that positions a plate-like workpiece to be welded in a jig, there has hitherto been known a device which is such that after a fixed positioning pin provided in a standing manner in the jig is inserted into a positioning hole of the workpiece, the workpiece is clamped by use of a clamping mechanism provided in the vicinity of the positioning pin to perform positioning (refer to Patent Document 1, for example).

### Patent Document 1: Japanese Patent Laid-Open No. 2-179364

However, in the case of a method that involves using such a fixed type positioning pin, when the size and position of the positioning hole of the workpiece change due to a change of the machine type, in general, it is necessary to prepare a new fixed type positioning pin or a multistage type positioning pin suitable for multiple machine types although a slight change in the positioning device can be coped with by an eccentric positioning pin.

In the fixed type positioning pin, work such as bolt removal and fastening occurs on the occasion of replacement, posing the problem that man-hours are long. In the multistage positioning pin, the mechanism of the forward and backward motions of the positioning pin to be used becomes complicated, posing the problem that the cost is high.

The present invention has been made in view of these problems with the conventional techniques, and the object of the invention is to provide a workpiece positioning device that facilitates the replacement work of a positioning pin and does not require a mechanical mechanism for clamping a workpiece.

### DISCLOSURE OF THE INVENTION

To solve the above-described problems, a first aspect of the present invention provides a workpiece positioning device that positions a workpiece by inserting a positioning pin into a positioning hole of the workpiece, and the workpiece positioning device comprises three locking members that grip the positioning pin in a protruding condition and exert a magnetic attractive force, and three sliding members that move each of the three locking members forward and backward radially with respect to the positioning pin.

According to a second aspect of the present invention, in the workpiece positioning device according to the first aspect, the positioning pin comprises a tip portion inserted into a positioning hole of the workpiece, a body portion that has a smaller diameter than the tip portion and is gripped by the three locking members, and a flanged portion having a larger diameter than the body portion.

According to a third aspect of the present invention, in the workpiece positioning device according to the first or second aspect, the locking member is formed as a columnar body, and grips the positioning pin with an outer circumferential surface thereof and magnetically attracts the workpiece with a top surface thereof.

According to a fourth aspect of the present invention, in the workpiece positioning device according to the first, second or third aspect, the magnetic attractive force of the locking member is adjusted by excitation means.

According to a fifth aspect of the present invention, in the workpiece positioning device according to the fourth aspect, the percentage of the area of the top surface of the locking member that comes into contact with the workpiece accounts for not less than 30% of the total top surface area.

According to the first aspect of the present invention, even when the shape and size of the positioning hole of the workpiece are changed, it is necessary only that a fitting positioning pin be gripped by the three locking members. Therefore, work, such as the removal and fastening of a bolt and positioning, becomes unnecessary and the man-hours for the installation can be reduced. Furthermore, by using the magnetic attractive force of the locking members, a mechanical clamping mechanism is unnecessary and the device and jig can be simplified. Also, because a workpiece is fixed by a magnetic attractive force, the workpiece is not dented or scratched.

According to the second aspect of the present invention, because the tip portion and the flanged portion function as a stopper, with the three locking members gripping the positioning pin, the positioning pin is positively fixed by the three locking members.

According to the third aspect of the present invention, the positioning pin can be positively fixed because the positioning pin is gripped with the outer circumferential surface of the columnar body, and the workpiece can be positively positioned because the workpiece can be magnetically attracted.

According to the fourth aspect of the present invention, the operability is good because by use of the excitation means it is possible to switch the locking member between excitation and nonexcitation and to adjust the intensity of the attractive force of the locking member.

According to the fifth aspect of the present invention, the workpiece can be positively positioned with a desirable attractive force.

### BRIEF DESCRIPTION OF THE DRAWINGS

FIG. 1 is a general perspective view of a workpiece positioning device related to the present invention;

FIG. 2 is a general side view of the workpiece positioning device related to the present invention;

FIG. 3 is a general plan view of the workpiece positioning device related to the present invention;

FIG. 4 is a side view of a positioning pin; and

FIGS. 5(a), 5(b) and 5(c) are diagrams to describe the operation of the workpiece positioning device and show locking members in an open condition, locking members in a closed position, and a workpiece positioning condition, respectively.

### BEST MODE FOR CARRYING OUT THE INVENTION

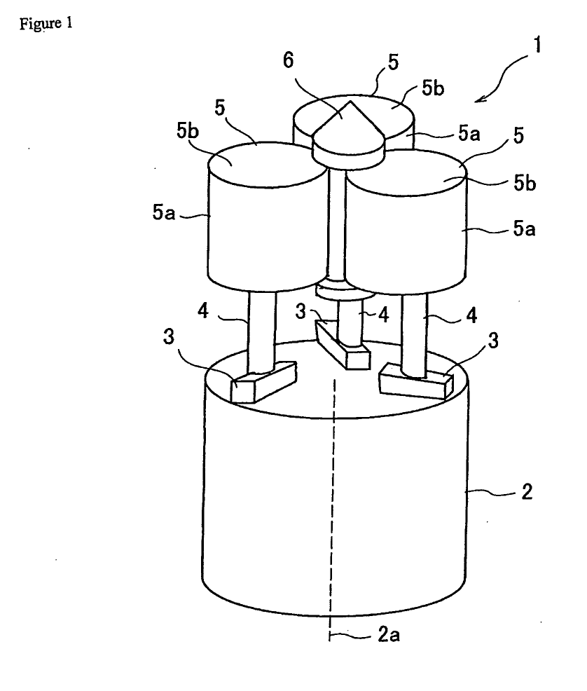

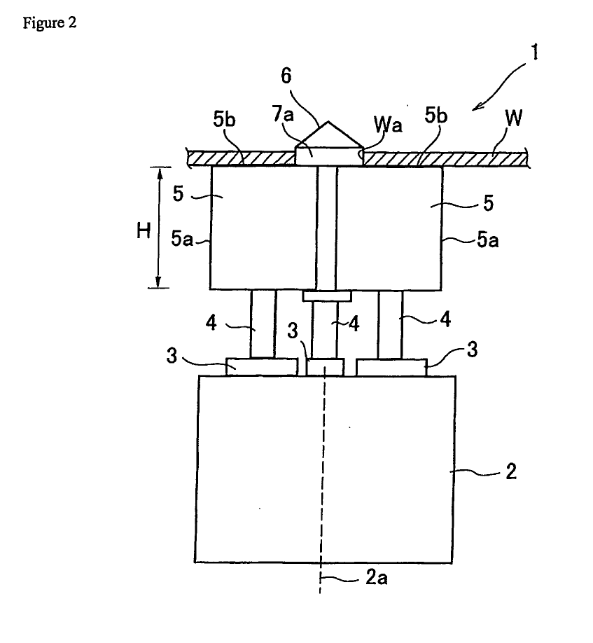

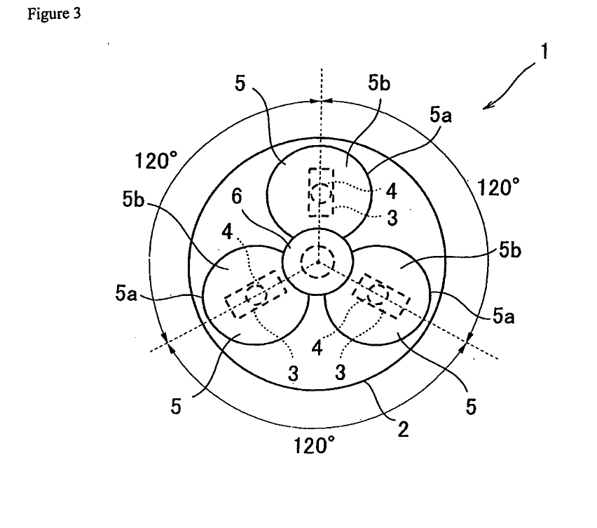

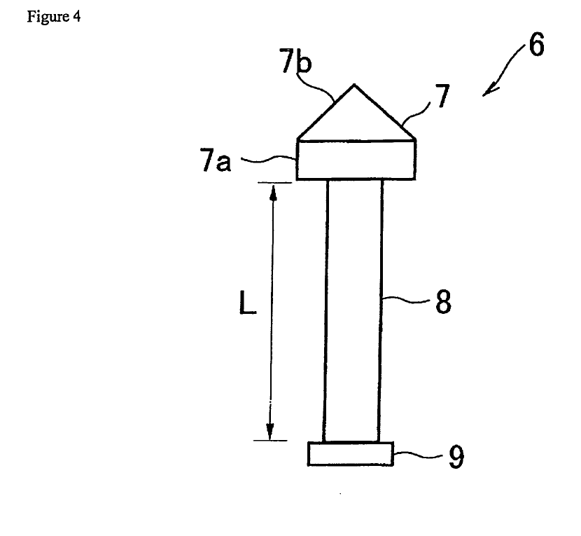

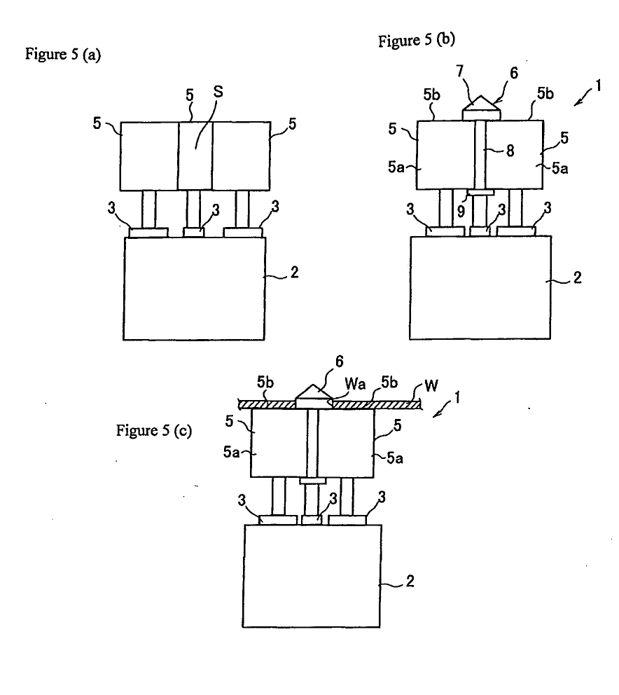

An embodiment of the present invention will be described below on the basis of the accompanying drawings. FIG. 1 is a general perspective view of a workpiece positioning device related to the present invention. FIG. 2 is a general side view of the workpiece positioning device. FIG. 3 is a general plan view of the workpiece positioning device. FIG. 4 is a side view of a positioning pin. FIGS. 5(a), 5(b) and 5(c) are diagrams to describe the operation of the workpiece positioning device.

As shown in FIGS. 1 to 3, the workpiece positioning device 1 related to the present invention comprises a chuck driving portion 2 in the shape of a cylindrical column, which is provided in a jig (not shown), three sliding members 3 that move forward and backward on a top surface of the chuck driving portion 2 radially from a central axis 2a of the chuck driving portion 2 at intervals of 120° in central angle, three locking members 5 that are attached to each of the three sliding members 3 each via a rod-like supporting member 4, and a positioning pin 6 that is gripped by the three locking members 5.

The chuck driving portion 2 can cause each of the three sliding members 3 to perform a forward motion or a backward motion by use of air pressure. The three locking members 5 perform a closing operation due to the forward motion of the sliding members 3, whereas the three locking members 5 perform an opening operation due to the backward motion of the sliding members 3. When the three locking members 5 come to a closed condition due to the closing operation thereof, the positioning pin 6 can be gripped with outer circumferential surfaces 5a of the locking members 5. When the three locking members 5 come to an open condition due to the opening operation thereof, a prescribed space S is formed among the three locking members 5 and the positioning pin 6 can be removed.

As shown in FIG. 2, the locking member 5 in the shape of a cylindrical column is excited by excitation means (not shown) and the workpiece W, which is a magnetic body, can be attracted onto a top surface 5b of the locking member 5. That is, each of the locking members 5 acts as an electromagnet. The intensity of the attractive force due to the top surface 5b of the locking member 5 can be adjusted by the excitation means. It is also possible to eliminate the attractive force by stopping the excitation of the locking member 5 by the excitation means. Thanks to this function, in loading and unloading the workpiece W to and from this device 1, it is necessary only that the excitation of the locking members 5 be stopped, and in positioning the workpiece W by use of this device 1, it is necessary only that the excitation of the locking members 5 be maintained, and the workpiece W positioning operation by this device 1 can be easily performed.

As shown in FIG. 4, the positioning pin 6 is formed by a tip portion 7 inserted into a positioning hole Wa of the workpiece W, a body portion 8 in the shape of a cylindrical column that has a smaller diameter than the tip portion 7 and is gripped with the outer circumferential surfaces 5a of the three locking members 5, and a flanged portion 9 having a larger diameter than the body portion 8. The tip portion 7 comprises a cylindrical column portion 7a and a sharply-pointed portion 7b in the shape of a circular cone, and the outside diameter of the cylindrical column portion 7a is a little smaller than the inside diameter of the positioning hole Wa of the workpiece W. Because the height H of the locking member 5 and the length L of the body portion 8 are formed to provide almost the same size (H<L), during the closing operation of the locking members 5 the body portion 8 is gripped with the outer circumferential surfaces 5a of the locking members 5.

With the three locking members 5 gripping the positioning pin 6, as shown in FIG. 3, part of the top surface 5b of each of the locking members 5 is equally covered with the tip portion 7 of the positioning pin 6. Therefore, the area of each top surface 5b except the part covered with the tip portion 7 contributes to the attraction of the workpiece W. In general, from the standpoint of attractive force, it is desirable that the percentage of the area of the top surface 5b of the locking member 5 that comes into contact with the workpiece W account for not less than 30% of the total top surface area.

A description will be given of the operation of the workpiece positioning device 1 according to the present invention that is constructed as described above. First, the chuck driving portion 2 is fixed in a desired position of a jig, and this device 1 except the positioning pin 6 is installed. Subsequently, as shown in FIG. 5(a), the excitation of the locking members 5 is stopped by using the excitation means and the chuck driving portion 2 is caused to move backward each of the three sliding members 3, whereby the three locking members 5 are brought in to an open condition. Then, the space S is formed among the three locking members 5.

Subsequently, with a positioning pin 6 that fits the positioning hole Wa of the workpiece W inserted into the space S, the chuck driving portion 2 is caused to move forward each of the sliding members 3, whereby the three locking members 5 are brought into a closed condition. Then, as shown in FIG. 5(b), the positioning pin 6 is gripped by the three locking members 5 and the tip portion 7 comes to a condition protruding from the top surfaces 5b of the locking members 5. At this time, the locking members 5 grip the body portion 8 while being sandwiched between the tip portion 7 and the flanged portion 9 and, therefore, the positioning pin 6 does not slip off due to impacts from the outside and the like.

When the workpiece W is placed in a prescribed position of the jig by means of a conveyance robot (not shown) or the like, with the positioning pin 6 gripped by the locking members 5 in this manner, as shown in FIG. 5(c), the tip portion 7 of the positioning pin 6 is inserted into the positioning hole Wa of the workpiece W and the workpiece W is positioned. Furthermore, the excitation of the locking members 5 is started and maintained by the excitation means, whereby the top surfaces 5b of the locking members 5 are magnetically attracted onto the workpiece W and the workpiece W is fixed to the jig.

The tip portion 7 of the positioning pin 6 is inserted into the positioning hole Wa of the workpiece W and the workpiece W is attracted onto the top surfaces 5b of the locking members 5 whereby the positioning in the jig is completed. Then, the processing operation, such as welding, of the workpiece W is performed by a robot (not shown) or the like. And when the operation by the robot or the like in the jig is competed, the excitation of the locking members S is stopped by using the excitation means and the workpiece W is released from the attraction by the magnetic force from the locking members 5. Then, the workpiece W is carried by the conveyance robot (not shown) or the like out of the jig.

When the machine type is changed and the size and shape of the positioning hole Wa of the workpiece W are changed, it is necessary only that the positioning pin 6 be replaced with a positioning pin 6 suited to the workpiece W. Incidentally, although the shape of the locking members 5 is a cylindrical column in this embodiment of the present invention, the shape is not restrictive so long as the shape enables the body portion 8 of the positioning pin 6 to be evenly gripped. Furthermore, although the locking members 5 are electromagnets in the embodiment of the present invention, it is possible to use permanent magnets if the magnetic force can be set at a relatively low value.

Moreover, according to this device 1, the instant the tip portion 7 of the positioning pin 6 is inserted into the positioning hole Wa of the workpiece W, the excitation of the locking members 5 is started by the excitation means, whereby the workpiece W can be immediately caused to be attracted onto the locking members 5. Therefore, it is not always necessary that the direction of the positioning pin 6 be the upward direction, but the lateral (horizontal) direction or the downward direction is permitted. Thus, this device I can be applied to the positioning hole Wa of a workpiece W that faces all directions.

### INDUSTRIAL APPLICABILITY

According to the present invention, even when the shape and size of the positioning hole of a workpiece, it is necessary only that a positioning pin suited to the workpiece be gripped by the three locking members. Therefore, it is possible to provide a workpiece positioning device that makes work, such as bolt removal and fastening and positioning, unnecessary and can reduce man-hours for installation. Furthermore, it is possible to provide a workpiece positioning device that does not require a mechanical clamping mechanism by using the magnetic attractive force of the locking members and enables the device and the jig to be simplified. In addition, it is possible to provide a workpiece positioning device that does not dent or scratch a workpiece because the workpiece is fixed by the magnetic attractive force.

1. A workpiece positioning device that positions a workpiece by inserting a positioning pin into a positioning hole of the workpiece, wherein the workpiece positioning device comprises three locking members that grip the positioning pin in a protruding condition and exert a magnetic attractive force, and three sliding members that move each of the three locking members forward and backward radially with respect to the positioning pin.

2. The workpiece positioning device according to claim 1, wherein the positioning pin comprises a tip portion inserted into a positioning hole of the workpiece, a body portion that has a smaller diameter than the tip portion and is gripped by the three locking members, and a flanged portion having a larger diameter than the body portion.

3. The workpiece positioning device according to claim 1, wherein the locking member is formed as a columnar body, and grips the positioning pin with an outer circumferential surface thereof and magnetically attracts the workpiece with a top surface thereof.

4. The workpiece positioning device according to claim 1, wherein the magnetic attractive force of the locking member is adjusted by excitation means.

5. The workpiece positioning device according to claim 4, wherein the percentage of the area of the top surface of the locking member that comes into contact with the workpiece accounts for not less than 30% of the total top surface area.

6. The workpiece positioning device according to claim 2, wherein the locking member is formed as a columnar body, and grips the positioning pin with an outer circumferential surface thereof and magnetically attracts the workpiece with a top surface thereof.

7. The workpiece positioning device according to claim 2, wherein the magnetic attractive force of the locking member is adjusted by excitation means.

8. The workpiece positioning device according to claim 3, wherein the magnetic attractive force of the locking member is adjusted by excitation means.
